(19) United States
(12) Patent Application Publication
(10) Pub. No.: US 2026/0037567 A1
(43) Pub. Date: Feb. 5, 2026

(54) MULTI-MACHINE LEARNING MODEL SYSTEM FOR UNSTRUCTURED DATA

(71) Applicant: HEWLETT PACKARD ENTERPRISE DEVELOPMENT LP, Spring, TX (US)

(72) Inventors: Satish Kumar Mopur, Bangalore (IN); Narsimha Nikhil Raj Padal, Bangalore (IN); Gunalan Perumal Vijayan, Bangalore (IN); Sridhar Balachandriah, Bangalore (IN); Kavi Chitra C, Bangalore (IN)

(21) Appl. No.: 18/894,295

(22) Filed: Sep. 24, 2024

(30) Foreign Application Priority Data
Aug. 2, 2024 (IN) 202441058694

(51) Int. Cl. G06F 16/35

(52) U.S. Cl. CPC G06F 16/353

(57) ABSTRACT

Systems and methods are provided for analyzing unstructured data using at least two machine learning models in a multi-machine learning model system, including (1) a supervised machine learning model that may be implemented as a transformer classifier-based entity recognition model operating on known entities (“crisp” entities), and (2) an unsupervised machine learning model that may be implemented as a transformer embedding-based model operating on unknown entities (“hazy” entities). The combination of the two models may execute a hierarchical and cascaded analysis of the input data that combines a clustering technique with a density-driven segregation of entities. Output of the multi-model system may help identify potential important information and non-relevant information to quickly examine critical incidents as well as possible non-relevant information.

### BACKGROUND

Several types of data are unstructured, such as log data from an information technology (IT) infrastructure, medical records with clinical data, and transcripts of live chat sessions with customers. As an example, log data from IT infrastructure systems is unstructured, in that it is not organized or stored as meaningful sentences. In some examples, the data lacks categorization and labeling, and the data can be ambiguous or abbreviated. Traditional systems may use Natural Language Processing (NLP) with unsupervised learning to cluster the log data into groups and separately analyze the groups of data. Analysis of unstructured data in such fields is important to determine operational insights that are visible in the log data.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates one example of a network configuration that may be implemented for an organization, such as a business, educational institution, governmental entity, healthcare facility or other organization.

FIG. 2 illustrates a multi-model system through concurrent processing of tokenization and model inference, in accordance with examples of the present disclosure.

FIG. 3 illustrates an attention process in the transformer identifying crisp entities, in accordance with examples of the present disclosure.

FIG. 4 illustrates an iterative clustering process with feedback, in accordance with examples of the present disclosure.

FIG. 5 are examples of output at a user interface, in accordance with examples of the present disclosure.

FIG. 6 is an example computing component that may be used to implement various features of a set of models in accordance with the implementations disclosed herein.

FIG. 7 is a computing component that may be used to implement examples of the disclosed technology.

The figures are not exhaustive and do not limit the present disclosure to the precise form disclosed.

### DETAILED DESCRIPTION

Examples of the disclosure provide a multi-machine learning model system (e.g., a “multi-model” system) analyzing unstructured data using at least two machine learning models, including (1) a supervised machine learning model that may be implemented as a transformer classifier-based entity recognition model operating on known entities (“crisp” entities), and (2) an unsupervised machine learning model that may be implemented as a transformer embedding-based model operating on unknown entities (“hazy” entities). The combination of the two models may execute a hierarchical and cascaded analysis of the input data that combines a clustering technique with a density-driven segregation of entities. Output of the multi-model system may help identify potential important information and non-relevant information to quickly examine critical incidents as well as possible non-relevant information.

As used herein, an “entity” is a term in the data that has a correlation to a physical/virtual device in a computing environment when the data relates to events occurring in the computing environment. The entity, for example, may be a device name, internet protocol (IP) address of a device, hexadecimal code of a system event, or variables corresponding with a device (e.g., EVENT LEVEL, TIMESTAMP, SYSTEM_IP). Events may be errors or warnings arising from a device with different levels of priority.

The entities in the data may be analyzed using the multi-model system that is further defined herein. For example, in a transformer classifier-based model corresponding with a supervised machine learning model, the system may generate a set of tokens from input text data prior to a training phase of the transformer classifier-based model. For example, in the input text, each token (e.g., word or subword) may be embedded into a vector space. The transformer encoder may process the token embeddings in parallel through multiple layers of self-attention and feed-forward neural networks. A classification head may be added with the transformer encoder that comprises one or more dense layers followed by a softmax layer (for multi-class classification) or sigmoid layer (for binary classification). Each token may be classified into predefined categories (e.g., a “crisp” entity or a “hazy” entity) based on the softmax/sigmoid outputs. During the training phase, the model is trained using annotated data where the token(s) in the text sequence are labeled with its corresponding entity type. The loss function used during training may correspond with a categorical cross-entropy for multi-class classification or binary cross-entropy for binary classification.

In the transformer embedding-based model, the system may utilize the transformer architecture to generate the embeddings as vector representations of the input tokens. The transformer embedding-based model may be implemented as an unsupervised machine learning model. In some examples, the transformer embedding-based model may be pre-trained on self-supervised learning tasks and then fine-tuned on specific downstream tasks, such as classification. In some examples, the pre-trained embeddings can be transferred to various NLP tasks.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

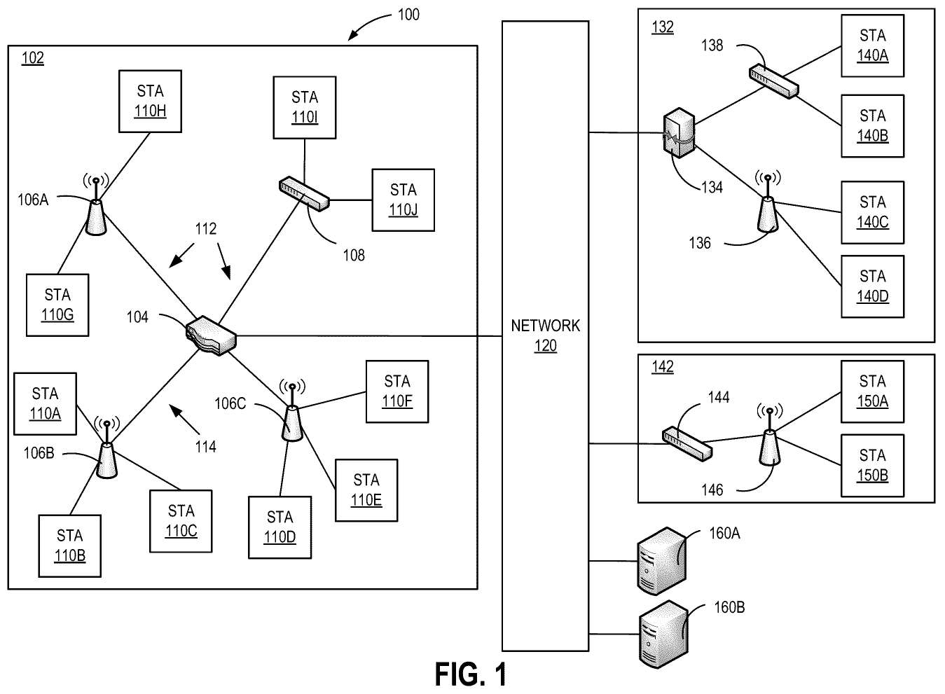

Before describing various examples of the disclosed systems and methods in detail, it is useful to describe an example network installation with which these systems and methods might be implemented in various applications. FIG. 1 illustrates one example of a network configuration 100 that may be implemented for an organization, such as a business, educational institution, governmental entity, healthcare facility or other organization. FIG. 1 illustrates an example of a configuration implemented with an organization having multiple users (or at least multiple client devices 110) and possibly multiple physical or geographical sites 102, 132, 142. Network configuration 100 may include primary site 102 in communication with network 120. Network configuration 100 may also include one or more remote sites 132, 142, that are in communication with the network 120. The system log data (e.g., unstructured data) may be generated from any of multiple client devices 110 from any of the multiple physical or geographical sites 102, 132, 142, or may be generated from a remote location that monitors the client devices. In either of these examples, the multi-model system at primary site 102 receives the data associated with multiple client devices 110.

Primary site 102 may include a primary network, which may be an office network, home network, or other network installation, for example. The primary network may be a private network, such as a network that may include security and access controls to restrict access to authorized users of the private network. Authorized users may include employees of a company at primary site 102, residents of a house, customers at a business, for example.

In the example of FIG. 1, primary site 102 includes controller 104, which is in communication with network 120. Controller 104 may provide communication with network 120 for primary site 102. There may be other points of communication with network 120 for primary site 102 in addition to controller 104. Although single device associated with controller 104 is illustrated, primary site 102 may include multiple controllers and/or multiple communication points with network 120. In some examples, controller 104 may communicate with network 120 through a router. In other examples, controller 104 provides router functionality to the devices in primary site 102. In this specification, the word “tunnel” refers to an encapsulated mode of transporting data between AP and controller.

Controller 104 may be operable to configure and manage network devices, such as at primary site 102, and may also manage network devices at remote sites 132, 142. Controller 104 may be operable to configure and/or manage switches, routers, access points, and/or client devices connected to a network. Controller 104 may itself be, or provide the functionality of, an Access Point (AP).

Controller 104 may be in communication with one or more switches 108 and/or wireless Access Points (APs) 106a-c. Switches 108 and wireless APs 106a-c provide network connectivity to various client devices 110a-j. Using a connection to switch 108 or AP 106a-c, client device 110a-j may access network resources, including other devices on the (primary site 102) network and network 120.

Examples of client devices may include: desktop computers, laptop computers, servers, web servers, authentication servers, authentication-authorization-accounting (AAA) servers, domain name system (DNS) servers, dynamic host configuration protocol (DHCP) servers, internet protocol (IP) servers, virtual private network (VPN) servers, network policy servers, mainframes, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, internet of things (IOT) devices, and the like. The examples may also include virtualized devices such as virtual machines or containers.

Within primary site 102, switch 108 is included as one example of a point of access to the network established in primary site 102 for wired client devices 110i-j. Client devices 110i-j may connect to switch 108 and through switch 108, may be able to access other devices within network configuration 100. Client devices 110i-j may also be able to access network 120, through switch 108. Client devices 110i-j may communicate with switch 108 over a wired or wireless connection 112. In the illustrated example, switch 108 communicates with controller 104 over a wired or wireless connection 112.

Wireless APs 106a-c are included as another example of a point of access to the network established in primary site 102 for client devices 110a-h. Each of APs 106a-c may be a combination of hardware, software, and/or firmware that is configured to provide wireless network connectivity to wireless client devices 110a-h. In the example of FIG. 1, APs 106a-c can be managed and configured by controller 104. APs 106a-c communicate with controller 104 and the network over connections 112, which may be either wired or wireless interfaces.

Network configuration 100 may include one or more remote sites 132. Remote site 132 may be located in a different physical or geographical location from primary site 102. In some cases, remote site 132 may be in the same geographical location, or possibly the same building, as primary site 102, but lacks a direct connection to the network located within primary site 102. Instead, remote site 132 may utilize a connection over a different network, e.g., network 120. Remote site 132 such as the one illustrated in FIG. 1 may be a satellite office, another floor or suite in a building, for example. Remote site 132 may include gateway device 134 for communicating with network 120. Gateway device 134 may be a router, a digital-to-analog modem, a cable modem, a digital subscriber line (DSL) modem, or some other network device configured to communicate with network 120. Remote site 132 may also include switch 138 and/or AP 136 in communication with gateway device 134 over either wired or wireless connections. Switch 138 and AP 136 provide connectivity to the network for various client devices 140a-d.

In various examples, remote site 132 may be in direct communication with primary site 102, such that client devices 140a-d at remote site 132 access the network resources at primary site 102 as if these client devices 140a-d were located at primary site 102. In such examples, remote site 132 is managed by controller 104 at primary site 102, and controller 104 provides the necessary connectivity, security, and accessibility that enable the connection between remote site 132 and primary site 102. Once connected to primary site 102, remote site 132 may function as a part of a private network provided by primary site 102.

In various examples, network configuration 100 may include one or more smaller remote sites 142, comprising only gateway device 144 for communicating with network 120 and wireless AP 146, by which various client devices 150a-b access network 120. Examples of remote site 142 may represent, for example, an individual employee's home or a temporary remote office. Remote site 142 may also be in communication with primary site 102, such that client devices 150a-b at remote site 142 access network resources at primary site 102 as if these client devices 150a-b were located at primary site 102. Remote site 142 may be managed by controller 104 at primary site 102 to make this transparency possible. Once connected to primary site 102, remote site 142 may function as a part of a private network provided by primary site 102.

Network 120 may be a public or private network, such as the Internet, or other communication network to allow connectivity among various sites 102, 132, 142 as well as access to servers 160a-b. Network 120 may include third-party telecommunication lines, such as phone lines, broadcast coaxial cable, fiber optic cables, satellite communications, cellular communications, and the like. Network 120 may include any number of intermediate network devices, such as switches, routers, gateways, servers, and/or controllers, which are not directly part of network configuration 100 but that facilitate communication between the various parts of the network configuration 100, and between the network configuration 100 and other network-connected entities. Network 120 may include various servers 160a-b. In an example, servers 160a-b may comprise content servers that include various providers of multimedia downloadable and/or streaming content, including audio, video, graphical, and/or text content, or any combination thereof. Examples of content servers 160a-b include web servers, streaming radio and video providers, and cable and satellite television providers. Client devices 110a-j, 140a-d, 150a-b may request and access the multimedia content provided by content servers 160a-b.

In another example, servers 106a-b may comprise flow optimization service server that include various information for provisioning services to client devices 110 a-j, 140a-d, 150a-b and optimizing traffic flows in accordance with the examples disclosed herein. Access points 106a-c, 136, and 146; switches 108; and gateway devices 134 and 144 may request or upload information, such as telemetry data, for optimizing rendering of services to client devices 110a-j, 140a-d, 150a-b. The information may include, but is not limited to, a measure or estimate of QoE on a per traffic flow basis (e.g., referred to herein as a QoE score); flow characteristics and other QoS measurements, such as but not limited to, jitter, delay, airtime, latency, etc.; analytics; transmission protocols (e.g., OFDMA and MU-MIMO), and the like. The information may be stored in a database, which can be communicatively coupled to servers 160a, 160b. In examples, servers 160a-b may be cloud-based, which would be understood by those of ordinary skill in the art to refer to being, e.g., remotely hosted on a system/servers in a network (rather than being hosted on local servers/computers) and remotely accessible.

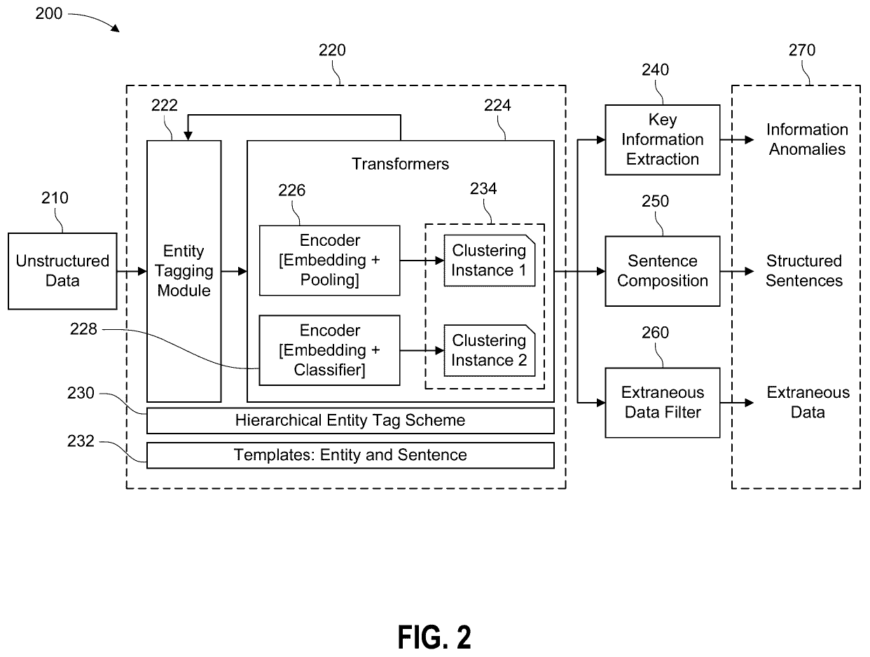

FIG. 2 illustrates a multi-model system through concurrent processing of tokenization and model inference, in accordance with examples of the present disclosure. In example 200, the multi-model system receives unstructured data 210 generated by one or more client devices located at a remote system(s). The unstructured text may correspond with various systems, including log data from an information technology (IT) infrastructure, medical records with clinical data, social media posts, or live chats with customers. In each of these instances, the data are non-uniform, with a large variety in content as unstructured or semi-structured text. Events and information such as errors, warnings, timestamps and addresses can vary in format. Further, the volume of log data generated is very high. For example, in a managed cloud environment, the system may generate real-time log data of the order of several GBs per day.

At block 220, unstructured data 210 may be analyzed. The unstructured data may comprise entity categories in unstructured data 210. The entity categories may comprise various labels or unique names, for example, “crisp,” “hazy,” or “not decipherable.” In some examples, the entity categories are pre-defined categories associated with the remote system are associated with a domain environment of the remote system that comprises device names in the remote system (e.g., client device names, AP names, STA names, etc.).

At block 222, an entity tagging module may receive unstructured data 210. For example, entity tagging module may define the entity categories. The entity categories may be defined as a set E={E1-C, E2-C, E3-H . . . En-H} where crisp entities correspond with the “C” category/label and hazy entities correspond with the “H” category/label. As an illustrative example of the set of entities in log data, E of LogData={Events-C, Date Time-H, IP Addresses-C, Additional Information-H}.

The entity tagging module may also assign an entity label. The entity labels may be unique, for example, Entity Label EL={EL1, EL2 . . . ELn} where “entity label” is a name for collection of labels under the category. For example, in log data, for Ex={events}, EL={erroneous, warnings, information}. For entities that are not “crisp” the default entity label may be assigned as “hazy.” In some examples, the Entity Label comprises unique label variants. The label variant EV={EV1, EV2 . . . EVn} where “entity variant” is a unique name for variants that are synonyms under the entity label set. For example, in log data, for an ELx=errors, EV={critical, fatal}.

The entity tagging module may abstract the data into key-value pairs (e.g., as <key:value>). For example, using a template of pre-defined entities 232, the system can define the “key” as the entity and “value” as the entity labels. In some examples, individual entities are grouped into a subclass (e.g., as an “entity label”) and multiple entity subclasses are grouped into an abstract entity. As a sample illustration, the log data can comprise a sentence that includes a timestamp, IPV4 address, IPv6 address, and hostnames. The IPV4 and IPV6 may be variants of addresses, so the system can classify the IPV4 and IPV6 into an abstract entity called “address.”

Other types of formatting may be implemented as well. For example, while IP addresses may be a known format in general technology environments, information that is meaningful and specific for a particular environment may be tagged as well. Entities added to the template may comprise user-defined terms, like the name of a server or other device, or protocol-defined terms, like a request/response code (e.g., defined in an IEEE communication protocol), are just some examples of recognizable data format that may be identified in the data and added to template of pre-defined entities 232.

In some examples, template of pre-defined entities 232 may comprise user-defined entities. For example, in log data, the entities may comprise EVENT LEVEL, TIMESTAMP, SYSTEM_IP, and other system variables and definitions. The user may define the entities through a user interface (e.g., YAML specification) as a list of entities (e.g., <key:multi-value>) where the key is the entity and values are the entity labels.

In some examples, the data may contain delimiters, which could be special characters such as a comma, a space, or other characters. Each data may be analyzed to determine its specific dialect. Once the dialect is identified, the sentence is divided into individual words.

In these and other processes of block 222, entity tagging module of the system may determine and tag the unstructured data to generate the tagged data. The entity categories may comprise a crisp entity category and a hazy entity category. The crisp entities may be associated with pre-defined categories associated with the remote system. The hazy entity category may exclude the pre-defined categories.

At block 224, tagged data comprising key-value pairs (e.g., as <key:value>) may be provided to a classifier module (e.g., transformers). For example, the classifier module may tokenize the tagged data to train the classifier for the particular domain that generated the initial set of log data. The domain may have specific commands and device names that are unique to the domain, which are determined to be “crisp” entities. All other entities may be “hazy” entities. The classifier module may generate a trained entity classifier model with the determined “crisp” and “hazy” entities.

In some examples, first encoder model (block 226) and second encoder model (block 228) may comprise a hierarchical entity tagging scheme (block 230). The entity tagging may define the entities in concise manner in conjunction with dialect analyzer and entity annotator. The dialect analyzer detects prominent delimiters (e.g. comma, space, semicolon, etc.) and splits the logs into tokens. The entity annotator labels the split tokens into crisp entities and hazy entities.

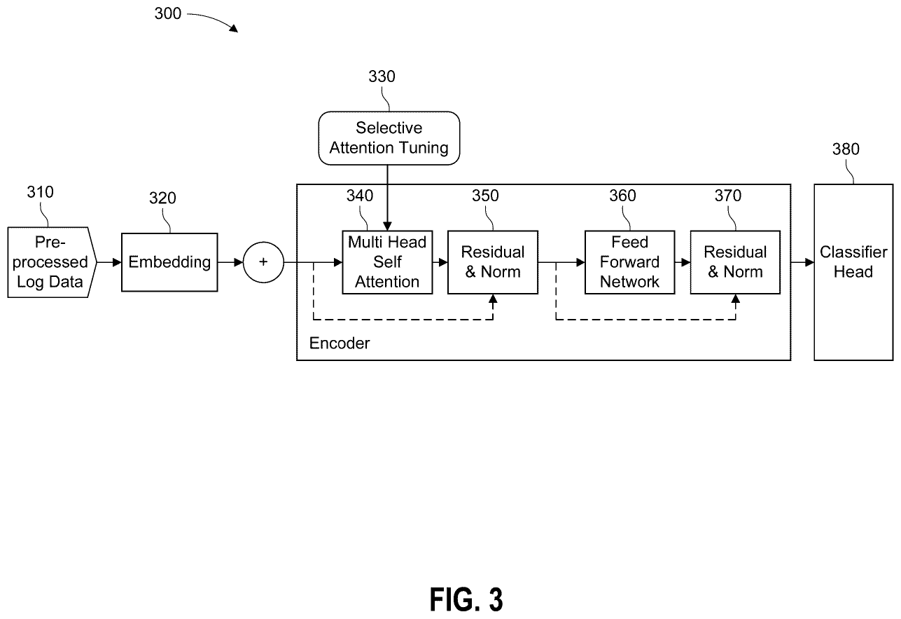

At block 226, a first encoder model may be implemented to generate a first clustering model of a set of clusters 234. The first clustering model may correspond with the “crisp” entities in the tagged data. For example, the encoder of the transformer can map an input sequence X1:n to embedding vectors E1:m (e.g., femb:X1:n→E1:m). The embedded vectors are provided to an unsupervised clustering model to predict the clusters Li={L1 . . . Lj}. A density analysis is performed on the clusters to identify dense and large count clusters (e.g., in comparison with a threshold value). The system may iteratively re-cluster the clusters to determine a minimum count (e.g., can be decided by average length of log sentence or otherwise tunable). Additional detail of the first encoder is provided with FIG. 3.

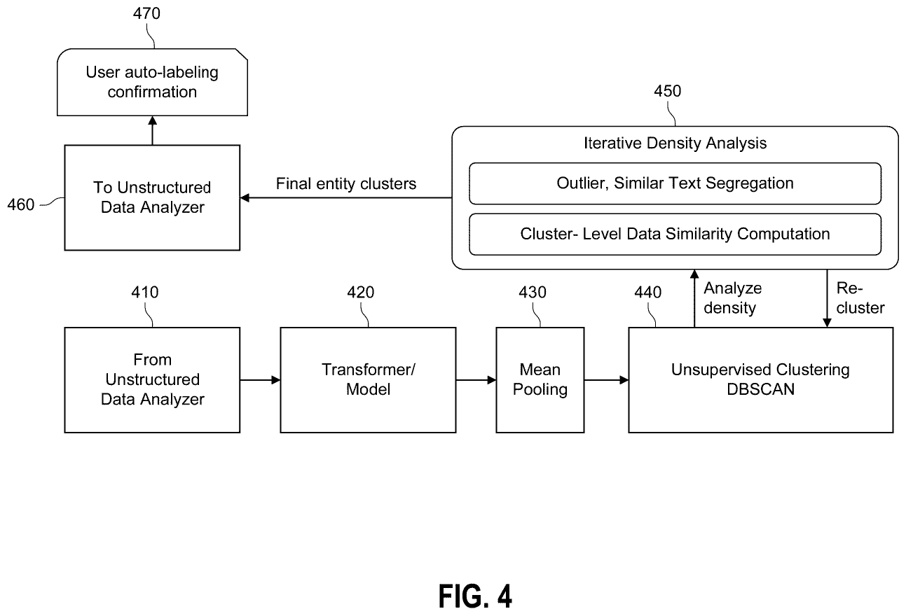

At block 228, a second encoder model may be implemented to generate a second clustering model of the set of clusters 234. The second clustering model may correspond with the “hazy” entities in the tagged data which are remaining entities that are not “crisp” entities. For example, data associated with the clusters are fed back to the unstructured data analyzer for auto-labelling and user confirmation on labels, followed by training of the transformer-classifier. Additional detail of the second encoder is provided with FIG. 4.

At block 240, information is extracted and anomalies may be generated from the extracted information. Anomalies are defined as outliers in data that are not expected to occur and need attention by a user. As an example, anomalies are detected from the clusters of the batch of data as follows.

As an illustrative example, let Cn be cluster with count ‘n’ for a batch ‘b’ of input data. The representative value of a cluster may be determined by a series of steps comprising (1): Extract core points from the clusters and store their values as a set CP={CP₁, CP₂ . . . CPn} for the ‘n’ clusters with batch ‘b’, (2) compute the distance (e.g., Euclidean Distance) between each pair of core points of the CP and store in a list EDb for batch b, (3) correlate successive ED values (e.g. EDb1 and Edb2) using a correlation technique (e.g. Pearson's correlation) where the absolute correlation value range is 0 to 1, and (4) if the correlation value is less than a threshold T, tag the latest cluster as containing potential anomalies. In some examples, the latest cluster may be provided to a display at a user device for review by a user. Threshold T may be tunable with default 0.5. A user may then tag the data as ‘Anomaly’ based on deeper inspection.

At block 250, sentence composition is initiated. The sentence template is used for all the entities, both crisp and hazy. The entities are filled into the template to compose a sentence.

At block 260, extraneous data filters are initiated and extraneous data may be identified based on the filters. The entities in the hazy entities which may not be of significance will be moved to the extraneous data. The user is given an option to tag the entities as not relevant.

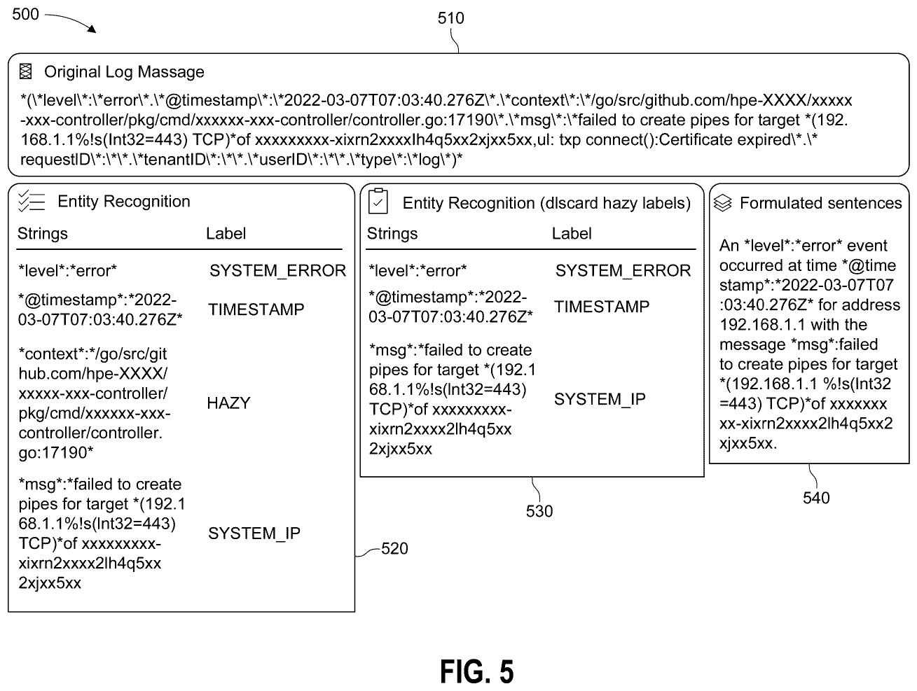

At block 270, output is generated. For example, the output may comprise information on anomalies (e.g., in log data), structured sentences, or identification of extraneous data. In some examples, the output includes providing the structured sentence to a user interface. Additional detail of the output is provided with FIG. 5.

FIG. 3 illustrates an attention process in the transformer identifying crisp entities, in accordance with examples of the present disclosure. In example 300, the system can implement a first model. The first model may correspond with a supervised machine learning model or a transformer classifier-based entity recognition model that is trained on entity data to identify known entities (e.g., “crisp” entities).

At block 310, the pre-processed data is received and at block 320, the pre-processed data is provided for embedding, as described herein. The processing may generate tokens that are provided as tagged data to the first model, e.g., to train the first model. During tokenization, the entities may be marked as “hazy” or otherwise unclear in input text with a special token (e.g. <UNCL>).

At block 330, the selective attention tuning is initiated. For example, the selective attention tuning can focus on crisp entities. In some examples, the selective attention tuning is a part of the multi-head attention of the encoder implemented as a module. The module may run through an attention mechanism multiple times and sometimes in parallel. In some examples, independent attention outputs associated with each of the heads may be concatenated and linearly transformed into the expected dimension. The multiple attention heads can allow the system to assess parts of the sequence differently (e.g., longer-term dependencies versus shorter-term dependencies).

At block 340, multi-head self-attention is initiated. During self-attention, the model can weigh the importance of different words in a sequence when predicting or generating the next word/token in the sequence. The process may compute a weighted sum of all the words/tokens in the input sequence, where the weights are determined by the similarity between pairs of words. In multi-head attention, the self-attention mechanism may be applied multiple times in parallel to the input, using different sets of learned weights to project the input into different subspaces (e.g., “hazy” subspace and other spaces). For example, the tokens corresponding with the label “hazy” may be assigned a lower weight with respect to a label threshold value. The transformer vectors corresponding with these tokens may be sent to the model/classifier for training. In some examples, the “crisp” entities may be one set of classes and “hazy” entities may be a second set of classes.

In some examples, the input sequence may be first transformed into three matrices, including Query (Q), Key (K), and Value (V) matrices. For each head, these matrices may be independently projected into different representation subspaces through learned linear transformations. The attention scores are computed separately for each head. The outputs of all heads are concatenated and linearly transformed to obtain the final multi-head attention output.

At block 350, residual connections and layer normalization (norm processing) may be initiated. The residual connection may be a direct connection from the input of a layer to its output, which can allow the network to learn residual functions in comparison to full transformations. In some examples, the residual connection can allow the gradients of the model to proceed more easily during backpropagation, particularly in very deep networks, to further improve convergence and training speed. The norm processing, the system may normalize the activations of each layer in the neural network to help stabilize the learning process by reducing the internal covariate shift. In some examples, norm processing may normalize the activations to have zero mean and unit variance across the features.

At block 360, a feed forward network is initiated to allow the information to flow in one direction without feedback loops. The feed forward network may be trained using supervised learning methods (e.g., gradient descent, backpropagation, etc.).

At block 370, residual and norm processing is initiated on the output from block 360, as discussed with block 350.

At block 380, a trained classifier head is stored. The output of the trained model corresponds with the entity labels for the “crisp” entities and “hazy” entities.

FIG. 4 illustrates an iterative clustering process with feedback, in accordance with examples of the present disclosure. In example 400, a second model may correspond with a semi-supervised transformer based model with unsupervised iterative clustering (“hazy” entities).

At block 410, the data is received from the unstructured data analyzer. At block 420, the unstructured data is provided to the transformer/model. The encoder of the transformer/model is configured to map an input sequence X1:n to embedding vectors E1:m. This is represented as femb:X1:n→E1:m.

At block 430, mean pooling is initiated. In mean pooling, the process determines an average of the values in the features map. The averaging determination may be repeated for different filter regions of the feature map. The determination of the average value may be limited to the filter region of the neuron in the model (e.g., any neural network (NN) model), and then repeated for progressively different filter regions in the feature map.

At block 440, unsupervised clustering model is initiated to help obtain fine-grained clustering. For example, the unsupervised clustering model may implement a transformer embedding model and an unsupervised iterative clustering algorithm to segregate “hazy” entities into clusters or buckets. The model may operate on embedding vectors E1:m to predict clusters Li={L1, . . . Lj}. This is represented as fUCI:E1:m→Li.

In some examples, the clusters may be dynamically generated based on pre-determined cluster density value. In other examples, the density may be based on a density threshold. The clusters with a number of entities that are in excess of the density threshold may correspond with an outlier entity.

At block 450, iterative density analysis is initiated. For example, on each cluster, the number of entities in each cluster is identified and compared with a threshold value. For clusters with counts that exceed the density threshold, the cluster may be labeled as a dense cluster or a large count cluster.

In some examples, block 440 and block 450 may be executed iteratively and/or sequentially. For example, the data from the unsupervised clustering model at block 440 may be provided for density analysis at block 450. From the density analysis, the process may re-cluster the data using the unsupervised clustering model. In some examples, the clusters may be are iteratively re-clustered to a minimum count (e.g., a second density threshold). The minimum count may be tunable and, in some examples, can be decided by average length of sentence in the input data.

In some examples, a custom batch optimizer (CBO) helps to execute the processing sequentially by creating multiple mini batches. The multiple mini batches may be executed on different GPUs/CPUs with the tokenizers for processing, which are then fed to the inference engine. This can help create a continuous tokenizing process as an inflow to the inference engine running on the GPUs/CPUs. For example, the process may identify a designated CPU count on the system (e.g., 30%) and create a queue of tokenizers. The tokenizers may be assigned as a round robin to the CPU count to calculate mini batches (e.g., tokenizer count divided by the CPU count). A CPU set may be assigned for the mini batches and the each tokenizer output may be provided to the inference engine (e.g., on the GPU).

At block 460, the final entity clusters may be provided back to the unstructured data analyzer. For example, the data associated with the clusters may be fed back to the unstructured data analyzer for auto-labelling. In some examples, at block 470, a user may provide feedback or confirmation on the automated labeling process, followed by training of the transformer-classifier.

FIG. 5 are examples of output at a user interface, in accordance with examples of the present disclosure. In example 500, the system can generate output to an interface to enable anomaly detection and information analysis of the data. For example, a formulated sentence is provided with additional output, including an unstructured log message 510, entity recognition 520, discarded non-relevant hazy entities 530, or formulated sentence 540.

In example 500, the entity labels are identified in the original sentence from the unstructured data. For example, unstructured log message 510 includes the sentence from the original data that is provided by the client devices at the remote system. In entity recognition 520, the entities from unstructured log message 510 are identified and labeled in association with the process described herein. The entities are labeled as, for example, “crisp” entities and “hazy” entities. In discarded non-relevant hazy entities 530, the entities associated with the “hazy” entities label are removed from the data. In formulated sentence 540, the entities that correspond with the entity label “crisp” remain and are used to form a sentence associated with the unstructured data. In some examples, formulated sentence 540 is not generated with any data associated with the “hazy” entity label.

Formulated sentence 540 may be based on a sentence template. As an illustrative example, the template may add values that are determined during the processing. For example, in log data, the sentence template may include “Event $level occurred at time $timestamp at IP $system_ip,” where “$level,” “$timestamp,” and “$system_ip,” are values that are determined at runtime and/or by the user through feedback with the user interface.

The formulated sentence may be customizable and multiple version of the sentence template may be generated. For example, the sentence template may be associated with a particular domain, client device, data type, or other distinguishing factor.

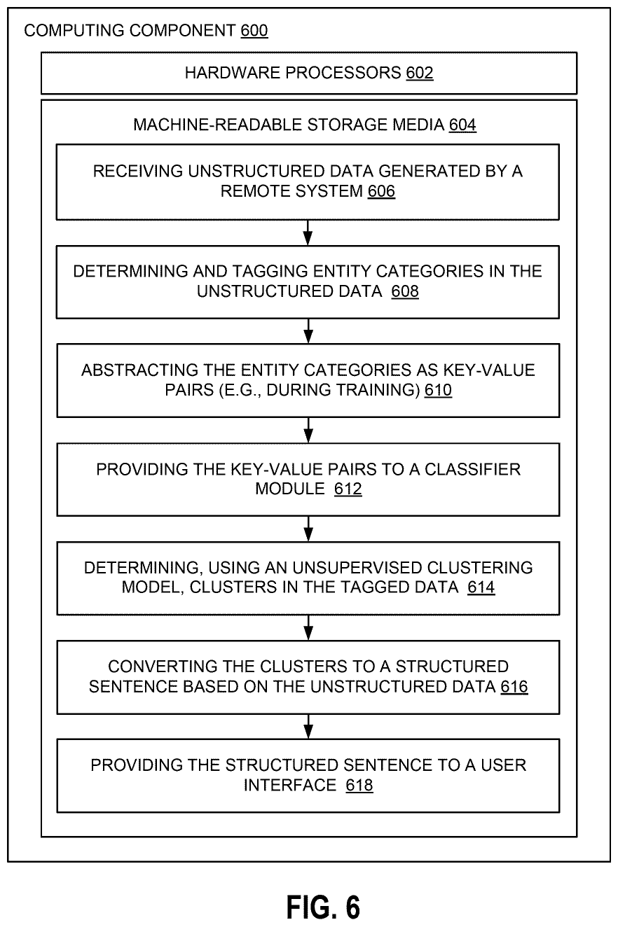

FIG. 6 illustrates a computing component that may be used to implement burst preloading for available bandwidth estimation in accordance with various examples of the disclosed technology. Referring now to FIG. 6, computing component 600 may be, for example, a server computer, a controller, or any other similar computing component capable of processing data. In the example implementation of FIG. 6, the computing component 600 includes hardware processor 602 and machine-readable storage medium 604.

Hardware processor 602 may be one or more central processing units (CPUs), semiconductor-based microprocessors, and/or other hardware devices suitable for retrieval and execution of instructions stored in machine-readable storage medium 604. Hardware processor 602 may fetch, decode, and execute instructions, such as instructions 606-618, to control processes or operations for burst preloading for available bandwidth estimation. As an alternative or in addition to retrieving and executing instructions, hardware processor 602 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 604, may be any electronic, magnetic, optical, or other physical storage device that contains or stores executable instructions. Thus, machine-readable storage medium 604 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 604 may be a non-transitory storage medium, where the term “non-transitory” does not encompass transitory propagating signals. As described in detail below, machine-readable storage medium 604 may be encoded with executable instructions, for example, instructions 606-618.

Hardware processor 602 may execute instruction 606 to receive unstructured data generated by a remote system. For example, the unstructured text may correspond with various systems, including log data from an information technology (IT) infrastructure, medical records with clinical data, social media posts, or live chats with customers. In each of these instances, the data are non-uniform, with a large variety in content as unstructured or semi-structured text. Events and information such as errors, warnings, timestamps and addresses can vary in format.

Hardware processor 602 may execute instruction 608 to determine and tag entity categories in the unstructured data. The unstructured data may comprise entity categories in unstructured data 210. The entity categories may comprise various labels or unique names, for example, “crisp,” “hazy,” or “not decipherable.” In some examples, the entity categories are pre-defined categories associated with the remote system are associated with a domain environment of the remote system that comprises device names in the remote system (e.g., client device names, AP names, STA names, etc.).

In some examples, an entity tagging module may receive unstructured data and define the entity categories. The entity categories may be defined as a set E={E1-C, E2-C, E3-H . . . En-H} where crisp entities correspond with the “C” category/label and hazy entities correspond with the “H” category/label. As an illustrative example of the set of entities in log data, E of LogData={Events-C, Date Time-H, IP Addresses-C, Additional Information-H}.

In some examples, the entity tagging module may also assign an entity label. The entity labels may be unique, for example, Entity Label EL={EL1, EL2 . . . . ELn} where “entity label” is a name for collection of labels under the category. For example, in log data, for Ex={events}, EL={erroneous, warnings, information}. For entities that are not “crisp” the default entity label may be assigned as “hazy.” In some examples, the Entity Label comprises unique label variants. The label variant EV={EV1, EV2 . . . EVn} where “entity variant” is a unique name for variants that are synonyms under the entity label set. For example, in log data, for an ELx=errors, EV={critical, fatal}.

Hardware processor 602 may execute instruction 610 to abstract entity categories as key-value pairs. For example, using a template of pre-defined entities, the system can define the “key” as the entity and “value” as the entity labels. In some examples, individual entities are grouped into a subclass (e.g., as an “entity label”) and multiple entity subclasses are grouped into an abstract entity. As a sample illustration, the log data can comprise a sentence that includes a timestamp, IPV4 address, IPv6 address, and hostnames. The IPV4 and IPV6 may be variants of addresses, so the system can classify the IPV4 and IPV6 into an abstract entity called “address.”

Other types of formatting may be implemented as well. For example, while IP addresses may be a known format in general technology environments, information that is meaningful and specific for a particular environment may be tagged as well. Entities added to the template may comprise user-defined terms, like the name of a server or other device, or protocol-defined terms, like a request/response code (e.g., defined in an IEEE communication protocol), are just some examples of recognizable data format that may be identified in the data and added to template of pre-defined entities.

In some examples, template of pre-defined entities may comprise user-defined entities. For example, in log data, the entities may comprise EVENT LEVEL, TIMESTAMP, SYSTEM_IP, and other system variables and definitions. The user may define the entities through a user interface (e.g., YAML specification) as a list of entities (e.g., <key:multi-value>) where the key is the entity and values are the entity labels.

In some examples, the data may contain delimiters, which could be special characters such as a comma, a space, or other characters. Each data may be analyzed to determine its specific dialect. Once the dialect is identified, the sentence is divided into individual words.

In these processes, entity tagging module of the system may determine and tag the unstructured data to generate the tagged data. The entity categories may comprise a crisp entity category and a hazy entity category. The crisp entities may be associated with pre-defined categories associated with the remote system. The hazy entity category may exclude the pre-defined categories.

In some examples, the abstraction may be performed as an additional step during training.

Hardware processor 602 may execute instruction 612 to provide the key-value pairs to a classifier module. For example, the classifier module may tokenize the tagged data to train the classifier for the particular domain that generated the initial set of log data. The domain may have specific commands and device names that are unique to the domain, which are determined to be “crisp” entities. All other entities may be “hazy” entities. The classifier module may generate a trained entity classifier model with the determined “crisp” and “hazy” entities.

In some examples, first encoder model and second encoder model may comprise a hierarchical entity tagging scheme. The entity tagging may define the entities in concise manner in conjunction with dialect analyzer and entity annotator. The dialect analyzer detects prominent delimiters (e.g. comma, space, semicolon, etc.) and splits the logs into tokens. The entity annotator labels the split tokens into crisp entities and hazy entities.

Hardware processor 602 may execute instruction 614 to determine clusters in the tagged data. Various encoders may be implemented. For example, a first encoder model may be implemented to generate a first clustering model of a set of clusters. The first clustering model may correspond with the “crisp” entities in the tagged data. For example, the encoder of the transformer can map an input sequence X1:n to embedding vectors E1:m (e.g., femb:X1:n [symbol] E1:m). The embedded vectors are provided to an unsupervised clustering model to predict the clusters Li={L1 . . . Lj}. A density analysis is performed on the clusters to identify dense and large count clusters (e.g., in comparison with a threshold value). The system may iteratively re-cluster the clusters to determine a minimum count (e.g., can be decided by average length of log sentence or otherwise tunable). A second encoder model may be implemented to generate a second clustering model of the set of clusters. The second clustering model may correspond with the “hazy” entities in the tagged data which are remaining entities that are not “crisp” entities. For example, data associated with the clusters are fed back to the unstructured data analyzer for auto-labelling and user confirmation on labels, followed by training of the transformer-classifier.

Hardware processor 602 may execute instruction 616 to convert the clusters to a structured sentence based on the unstructured data. For example, the output may comprise information on anomalies (e.g., in log data), structured sentences, or identification of extraneous data.

In some examples, the sentence may be based on a sentence template. As an illustrative example, the template may add values that are determined during the processing. For example, in log data, the sentence template may include “Event $level occurred at time $timestamp at IP $system_ip,” where “$level,” “$timestamp,” and “$system_ip,” are values that are determined at runtime and/or by the user through feedback with the user interface. The formulated sentence may be customizable and multiple version of the sentence template may be generated. For example, the sentence template may be associated with a particular domain, client device, data type, or other distinguishing factor.

Hardware processor 602 may execute instruction 618 to provide the structured sentence to a user interface. The user interface may display the sentence illustrated in FIG. 5, or other information, including a chart or graph showing the association of the entity labels to origins of the data from the remote system or particular client devices.

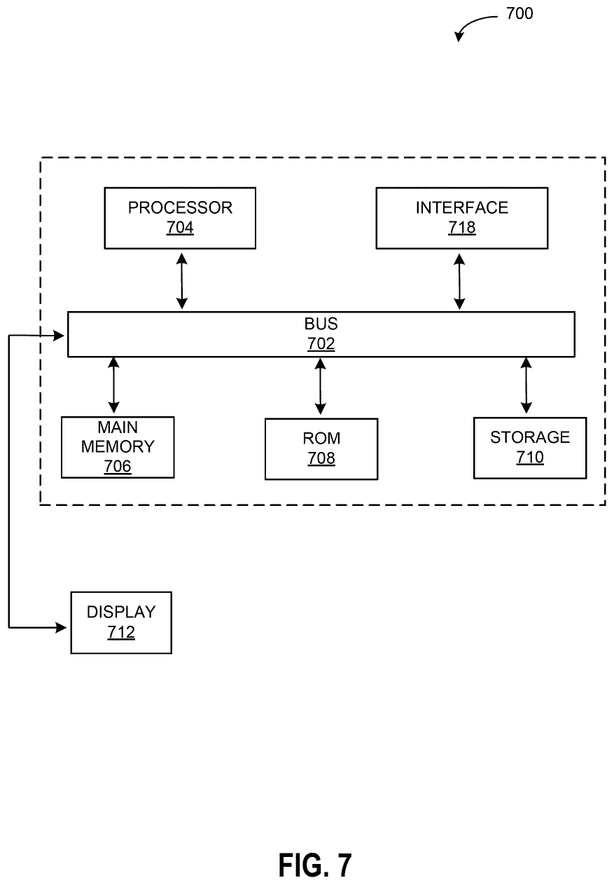

FIG. 7 depicts a block diagram of an example computer system 700 in which various examples of the disclosed technology described herein may be implemented. Computer system 700 includes bus 702 or other communication mechanism for communicating information, one or more hardware processors 704 coupled with bus 702 for processing information. Hardware processor(s) 704 may be, for example, one or more general purpose microprocessors.

Computer system 700 also includes main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

Computer system 700 further includes read only memory (ROM) 708 or other static storage device coupled to bus 702 for storing static information and instructions for processor 704. Storage device 710, such as a magnetic disk, optical disk, or USB thumb drive (Flash drive), etc., is provided and coupled to bus 702 for storing information and instructions.

Computer system 700 may be coupled via bus 702 to display 712, such as a liquid crystal display (LCD) (or touch screen), for displaying information to a computer user. The information may include, for example, the formulated sentence illustrated in FIG. 5, or other information, including a chart or graph showing the association of the entity labels to origins of the data from the remote system or particular client devices illustrated in FIG. 1.

Computer system 700 may include a user interface module to implement a GUI to provide to display 712. The user interface module may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

Computer system 700 may implement the techniques described herein using customized hard-wired logic, one or more ASICs or FPGAs, firmware and/or program logic which in combination with the computer system causes or programs computer system 700 to be a special-purpose machine. According to one example of the disclosed technology, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 702. Transmission media can also take the form of acoustic or light waves, such as those generated during radio-wave and infra-red data communications.

Computer system 700 also includes interface 718 coupled to bus 702. Interface 718 provides a two-way data communication coupling to one or more network links that are connected to one or more local networks. For example, interface 718 may be an integrated services digital network (ISDN) card, cable modem, satellite modem, or a modem to provide a data communication connection to a corresponding type of telephone line. As another example, interface 718 may be a local area network (LAN) card to provide a data communication connection to a compatible LAN (or WAN component to communicate with a WAN). Wireless links may also be implemented. In any such implementation, interface 718 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through interface 718, which carry the digital data to and from computer system 700, are example forms of transmission media.

Computer system 700 can send messages and receive data, including program code, through the network(s), network link and interface 718. In the Internet example, a server might transmit a requested code for an application program through the Internet, the ISP, the local network and interface 718.

The received code may be executed by processor 704 as it is received, and/or stored in storage device 710, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 700.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

1. A computer-implemented method comprising:
receiving, at a computer system, unstructured data generated by a remote system;
determining and tagging, by the computer system, entity categories in the unstructured data to generate tagged data, wherein the entity categories comprise a crisp entity category that is associated with a plurality of pre-defined categories associated with the remote system and a hazy entity category that excludes the pre-defined categories;
converting, by the computer system, the entity categories to a set of key-value pairs, wherein individual ones of the set of key-value pairs comprise a respective key corresponding to a type of activity or event associated with the unstructured data and a respective value indicative of a characteristic of the type of activity or event;
providing, by the computer system, the key-value pairs to a classifier module that is configured to tokenize the tagged data, wherein based on the providing, a first output of the classifier module includes a set of crisp entities associated with the crisp entity category and a second output of the classifier module includes a set of hazy entities associated with the hazy entity category;
feeding back the second output of the classifier module including the set of hazy entities to an unstructured data analyzer module that is configured to output newly tagged data that includes one or more new tags for the set of hazy entities, wherein the one or more new tags corresponds to the set of crisp entities;
determining, by the computer system, clusters in the tagged data and the newly tagged data;
converting the clusters to a structured sentence based on the unstructured data; and
providing the structured sentence to a user interface.

2. The method of claim 1, wherein the clusters are determined using an unsupervised clustering model.

3. The method of claim 1, wherein the unstructured data is log data, and the remote system is a distributed information technology system that generates the unstructured data.

4. The method of claim 1, wherein the pre-defined categories associated with the remote system are associated with a domain environment of the remote system that comprises device names in the remote system.

5. The method of claim 1, wherein the classifier module is executed concurrently on the tagged data with an unsupervised clustering model that generates the clusters.

6. The method of claim 1, further comprising iteratively re-clustering the clusters in the tagged data to a minimum count of clusters.

7. The method of claim 6, wherein the re-clustering compares a number of entities in the cluster with a density threshold and the method further comprises:
tagging a cluster with the number of entities that are in excess of the density threshold may correspond as an outlier entity.

8. The method of claim 6, wherein the re-clustering generates clusters based on a pre-determined cluster density value.

9. A system comprising:
a memory; and
a processor that are configured to execute machine readable instructions stored in the memory for causing the processor to:
receive unstructured data generated by a remote system;
determine and tag entity categories in the unstructured data to generate tagged data, wherein the entity categories comprise a crisp entity category that is associated with a plurality of pre-defined categories associated with the remote system and a hazy entity category that excludes the pre-defined categories;
convert the entity categories to a set of key-value pairs, wherein individual ones of the set of key-value pairs comprise a respective key corresponding to a type of activity or event associated with the unstructured data and a respective value indicative of a characteristic of the type of activity or event;
provide the key-value pairs to a classifier module that is configured to tokenize the tagged data, wherein based on the providing, a first output of the classifier module includes a set of crisp entities associated with the crisp entity category and a second output of the classifier module includes a set of hazy entities associated with the hazy entity category;
feed back the second output of the classifier module including the set of hazy entities to an unstructured data analyzer module that is configured to output newly tagged data that includes one or more new tags for the set of hazy entities, wherein the one or more new tags corresponds to the set of crisp entities;
determine clusters in the tagged data and the newly tagged data;
convert the clusters to a structured sentence based on the unstructured data; and
provide the structured sentence to a user interface.

10. The system of claim 9, wherein the clusters are determined using an unsupervised clustering model.

11. The system of claim 9, wherein the unstructured data is log data, and the remote system is a distributed information technology system that generates the unstructured data.

12. The system of claim 9, wherein the pre-defined categories associated with the remote system are associated with a domain environment of the remote system that comprises device names in the remote system.

13. The system of claim 9, wherein the classifier module is executed concurrently on the tagged data with an unsupervised clustering model that generates the clusters.

14. The system of claim 9, further comprising iteratively re-clustering the clusters in the tagged data to a minimum count of clusters.

15. The system of claim 14, wherein the re-clustering compares a number of entities in the cluster with a density threshold and the processor is further to:
tag a cluster with the number of entities that are in excess of the density threshold may correspond as an outlier entity.

16. The system of claim 14, wherein the re-clustering generates clusters based on a pre-determined cluster density value.

17. A non-transitory computer-readable storage medium storing a plurality of instructions executable by a processor, the plurality of instructions when executed by the processor cause the processor to:
receive unstructured data generated by a remote system;
determine and tag entity categories in the unstructured data to generate tagged data, wherein the entity categories comprise a crisp entity category that is associated with a plurality of pre-defined categories associated with the remote system and a hazy entity category that excludes the pre-defined categories;
convert the entity categories to a set of key-value pairs, wherein individual ones of the set of key-value pairs comprise a respective key corresponding to a type of activity or event associated with the unstructured data and a respective value indicative of a characteristic of the type of activity or event;
provide the key-value pairs to a classifier module that is configured to tokenize the tagged data, wherein based on the providing, a first output of the classifier module includes a set of crisp entities associated with the crisp entity category and a second output of the classifier module includes a set of hazy entities associated with the hazy entity category;
feed back the second output of the classifier module including the set of hazy entities to an unstructured data analyzer module that is configured to output newly tagged data that includes one or more new tags for the set of hazy entities, wherein the one or more new tags corresponds to the set of crisp entities;
determine clusters in the tagged data and the newly tagged data;
convert the clusters to a structured sentence based on the unstructured data; and
provide the structured sentence to a user interface.

18. The non-transitory computer-readable storage medium of claim 17, wherein the clusters are determined using an unsupervised clustering model.

19. The non-transitory computer-readable storage medium of claim 17, wherein the unstructured data is log data, and the remote system is a distributed information technology system that generates the unstructured data.

20. The non-transitory computer-readable storage medium of claim 17, wherein the pre-defined categories associated with the remote system are associated with a domain environment of the remote system that comprises device names in the remote system.
